(19) United States
(12) Patent Application Publication
(10) Pub. No.: US 2007/0091767 A1
(43) Pub. Date: Apr. 26, 2007

(54) Holographic reading device

(75) Inventor: Coen Liedenbaum, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/595,969

(22) PCT Filed: Nov. 26, 2004
(86) PCT No.: PCT/IB04/03951

§ 371 Date: Jun. 5, 2006

(30) Foreign Application Priority Data
Dec. 8, 2003 (EP) 03078842.6
Jul. 29, 2004 (EP) 04300491.0

(51) Int. Cl. G11B 7/00

(52) U.S. Cl. 369/103

(57) ABSTRACT

The invention relates to an optical holographic device for reading out a data page recorded in a holographic medium (202). The data page comprises data bits. The device comprises means (200) for producing a radiation beam having an intensity, means (201) for directing the radiation beam towards the holographic medium so as to image the data page, means (203) for detecting a set of imaged data bits in the imaged data page, means (204) for counting, among the set of imaged data bits, the number of imaged data bits having a predetermined data state and means (205) for modifying the intensity as a function of this number.

### FIELD OF THE INVENTION

The present invention relates to an optical holographic device for reading out a data page recorded in a holographic medium, to a method for reading out such a data page and to a computer program for carrying out such a method.

### BACKGROUND OF THE INVENTION

An optical device capable of recording on and reading from a holographic medium is known from H. J. Coufal, D. Psaltis, G. T. Sincerbox (Eds.), ‘Holographic data storage’, Springer series in optical sciences, (2000). FIG. 1 shows such an optical device. This optical device comprises a radiation source 100, a collimator 101, a first beam splitter 102, a spatial light modulator 103, a second beam splitter 104, a lens 105, a first deflector 107, a first telescope 108, a first mirror 109, a half wave plate 110, a second mirror 111, a second deflector 112, a second telescope 113 and a detector 114. The optical device is intended to record in and read data from a holographic medium 106.

During recording of a data page in the holographic medium, half of the radiation beam generated by the radiation source 100 is sent towards the spatial light modulator 103 by means of the first beam splitter 102. This portion of the radiation beam is called the signal beam. Half of the radiation beam generated by the radiation source 100 is deflected towards the telescope 108 by means of the first deflector 107. This portion of the radiation beam is called the reference beam. The signal beam is spatially modulated by means of the spatial light modulator 103. The spatial light modulator comprises transmissive areas and absorbent areas, which corresponds to zero and one data-bits of a data page to be recorded. After the signal beam has passed through the spatial light modulator 103, it carries the signal to be recorded in the holographic medium 106, i.e. the data page to be recorded. The signal beam is then focused on the holographic medium 106 by means of the lens 105.

The reference beam is also focused on the holographic medium 106 by means of the first telescope 108. The data page is thus recorded in the holographic medium 106, in the form of an interference pattern as a result of interference between the signal beam and the reference beam. Once a data page has been recorded in the holographic medium 106, another data page is recorded at a same location of the holographic medium 106. To this end, data corresponding to this data page are sent to the spatial light modulator 103. The first deflector 107 is rotated so that the angle of the reference signal with respect to the holographic medium 106 is modified. The first telescope 108 is used to keep the reference beam at the same position while rotating. An interference pattern is thus recorded with a different pattern at a same location of the holographic medium 106. This is called angle multiplexing. A same location of the holographic medium 106 where a plurality of data pages is recorded is called a book.

Alternatively, the wavelength of the radiation beam may be tuned in order to record different data pages in a same book. This is called wavelength multiplexing. Other kind of multiplexing, such as shift multiplexing, may also be used for recording data pages in the holographic medium 106.

During readout of a data page from the holographic medium 106, the spatial light modulator 103 is made completely absorbent, so that no portion of the beam can pass trough the spatial light modulator 103. The first deflector 107 is removed, such that the portion of the beam generated by the radiation source 100 that passes through the beam splitter 102 reaches the second deflector 112 via the first mirror 109, the half wave plate 110 and the second mirror 111. If angle multiplexing has been used for recording the data pages in the holographic medium 106, and a given data page is to be read out, the second deflector 112 is arranged in such a way that its angle with respect to the holographic medium 106 is the same as the angle that were used for recording this given hologram. The signal that is deflected by the second deflector 112 and focused in the holographic medium 106 by means of the second telescope 113 is thus the phase conjugate of the reference signal that were used for recording this given hologram. If for instance wavelength multiplexing has been used for recording the data pages in the holographic medium 106, and a given data page is to be read out, the same wavelength is used for reading this given data page.

The phase conjugate of the reference signal is then diffracted by the information pattern, which creates a reconstructed signal beam, which then reaches the detector 114 via the lens 105 and the second beam splitter 104. An imaged data page is thus created on the detector 114, and detected by said detector 114. The detector 114 comprises pixels or detector elements, each detector element corresponding to a bit of the imaged data page.

The holographic medium 106 thus comprises a plurality of data pages having different data bits distribution. In a simple example, the data bits of a data page have 2 possible data states, such as “1” and “0”. Theoretically, a first intensity on the detector 114 corresponds to a first data state and a second intensity corresponds to a second data state. However, due to various factors, data bits having the same data state may be represented by different intensities on the detector 114. These factors include, inter alia, variations in the diffraction efficiency of the recorded data pages or power fluctuations in the output power of the radiation source 100 during recording. These variations may be so important that data bits having two different data states are represented by equal intensities on the detector 114. As a consequence, it is not possible to detect the data state of a data bit by simply monitoring the intensity of the imaged data bit on the detector 114.

U.S. Pat. No. 5,995,676 describes a method for determining the data states of data bits in a holographic device. According to this method, the intensities of a set of imaged data bits are measured. For example, the intensities of all the imaged data bits of an imaged data page are measured. Then, the average value of these intensities is measured, and the intensity of each imaged data bit is compared to this average value. If an intensity is inferior to the average value, it is decided that the data state of the corresponding imaged data bit is 0. If an intensity is superior to the average value, it is decided that the data state of the corresponding imaged data bit is 1.

A drawback of this method is the following. Due to variations in the diffraction efficiency of the recorded data pages and power fluctuations in the output power of the radiation source 100 during recording, it is possible that the average intensity on the detector 114 is relatively low. When the average intensity on the detector 114 is low, the method is sensitive to noise. Actually, different sources of noise, such as the dark current of the detector 114 itself, contribute to the intensity of an imaged data bit. This noise may be as high as the average intensity without noise. As a consequence, the method leads to wrong results. For example, a data bit which should have data state 0 may be identified as data state 1, because the noise of the pixel of the detector 114 corresponding to said data bit is relatively large.

### SUMMARY OF THE INVENTION

It is an object of the invention to provide a holographic device which is less sensitive to noise.

To this end, the invention proposes an optical holographic device for reading out a data page recorded in a holographic medium, said data page comprising data bits, the device comprising means for producing a radiation beam having an intensity, means for directing said radiation beam towards said holographic medium so as to image said data page, means for detecting a set of imaged data bits in said imaged data page, means for counting, among said set of imaged data bits, the number of imaged data bits having a predetermined data state and means for modifying said intensity as a function of said number.

According to the invention, the number of imaged data bits having a predetermined data state is counted and the intensity of the radiation beam is adjusted as a function of said number. It is thus possible to keep the average intensity on the detector at a relatively high level, where contribution of noise is relatively low.

Advantageously, the means for counting comprise at least one comparator for comparing the value of an imaged data bit with a predetermined threshold. A simple decision circuit can thus be used for counting the number of imaged data bits having a predetermined data state. As a consequence, this avoids use of an analogue to digital converter after each detector pixel. The cost of the holographic device is thus reduced and the user bitrate is increased.

Preferably, the means for modifying the intensity of the radiation beam are arranged for modifying the intensity of the radiation beam until said number represents between 40 percent and 60 percent of the number of imaged data bits of said set of imaged data bits. In conventional holographic devices, the data bits can have only two data states. The data pages are usually encoded in such a way that the number of data bits having the first state does not differ more than 20 percent with the number of data bits having the second state. According to the invention, the intensity of the radiation beam is modified until the same distribution is retrieved in the imaged data page. More preferably, the above-mentioned percentage is substantially equal to 50 percent. Actually, an equal distribution of first and second states is often used for encoding a data page.

The invention also relates to a method for reading out a data page recorded in a holographic medium, said data page comprising data bits, said method comprising a step of forming an imaged data page from said data page on detecting means by means of a radiation beam having an intensity, a step of detecting a set of imaged data bits in said imaged data page, a step of counting, among said set of imaged data bits, the number of imaged data bits having a predetermined data state and a step of modifying said intensity as a function of said number.

The invention further relates to a computer program comprising a set of instructions which, when loaded into a processor or a computer, causes the processor or the computer to carry out this method.

### BRIEF DESCRIPTION OF THE DRAWINGS

The invention will now be described in more detail by way of example with reference to the accompanying drawings, in which:

FIG. 1 shows a holographic device in accordance with the prior art;

FIG. 2 shows a holographic device in accordance with the invention;

FIG. 3 illustrates the method in accordance with the invention;

FIG. 4 shows a comparator used in the holographic device in accordance with the invention.

### DETAILED DESCRIPTION OF THE INVENTION

In this application, the expression “data bit” corresponds to a data bit of a data page in the holographic medium, whereas the expression “imaged data bit” corresponds to a data bit of an imaged data page on the detector. The measured data state of an imaged data bit may not correspond to the data state of the corresponding data bit. The goal of the invention is that the measured data state of an imaged data bit really corresponds to the data state of the corresponding data bit.

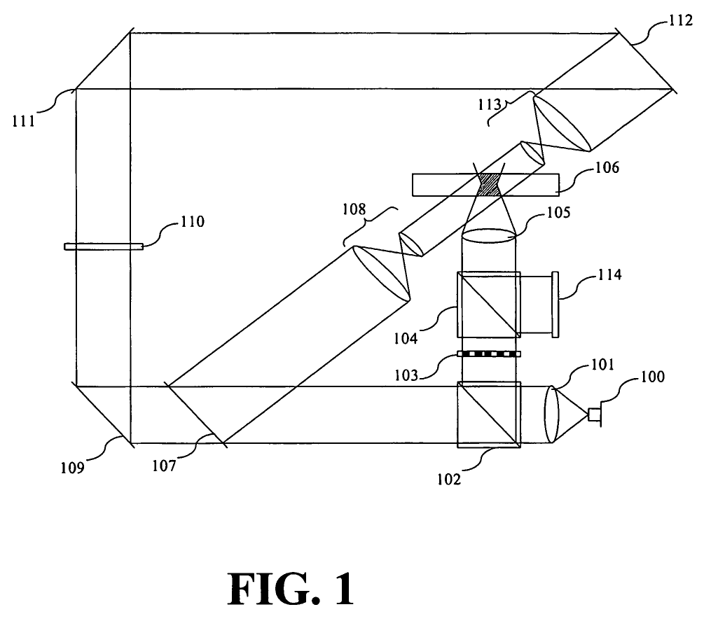

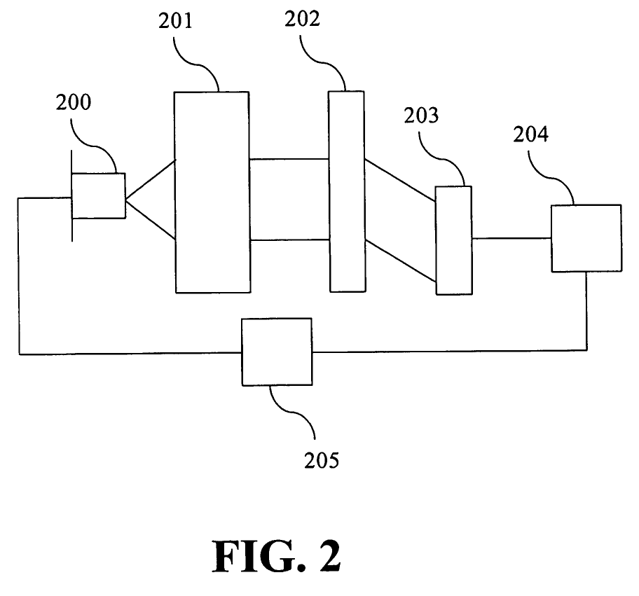

FIG. 2 diagrammatically shows a holographic device in accordance with the invention. The holographic device comprises a radiation source 200 for producing a radiation beam, means 201 for directing said radiation beam towards a holographic medium 202, detecting means 203 for detecting intensities of imaged data bits of an imaged data page, counting means 204 and means 205 for modifying the intensity of the radiation beam. The directing means 201 are conventional means for directing a radiation beam towards an information carrier. It may comprise optical elements such as the second telescope 113 of FIG. 1.

The radiation beam is diffracted by the holographic medium 202, and an imaged data page is formed on the detecting means 203. The imaged data page comprises imaged data bits. The detecting means 203 is a detector array comprising pixels. Preferably, the number of pixels is equal to the number of imaged data bits of the imaged data page, although this is not required for implementing the invention. The counting means 204 are adapted for counting, among a set of imaged data bits, the number of imaged data bits having a predetermined data state. Depending on this number, the intensity of the radiation beam is modified. To this end, the holographic device comprises the modifying means 205, which are controlled by the output of the counting means 204.

In the following description, there are two possible data states for a data bit, a high data state and a low data state. However, the invention can be applied to holographic devices where the data are encoded with more than two data states.

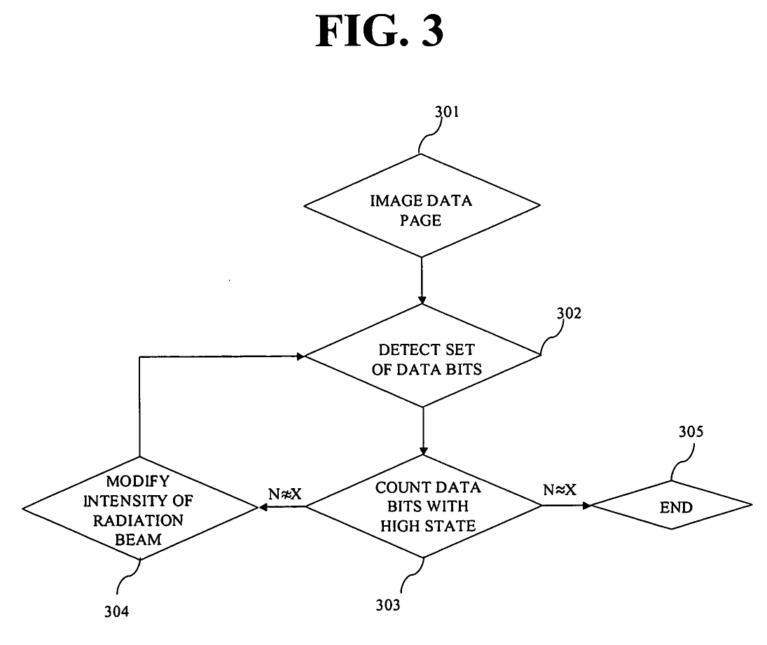

FIG. 3 illustrates the method in accordance with the invention. At step 301, an image is formed on the detecting means 203. At step 302, a set of imaged data bits is detected. This set can be a portion of the imaged data page, or the whole imaged data page, as will be explained later. At step 303, the number of imaged data bits having a predetermined data state is counted. In this example, the number of imaged data bits with a high state is counted. This is performed in a simple way, for example by comparison of the intensity of the imaged data bit with a predetermined threshold. For example, if the intensities of the imaged data bits in a plurality of holographic mediums vary between 0 and 100 in arbitrary units, the threshold may be chosen equal to 50. The number N of imaged data bits with a high state is then compared to a number X, which corresponds to the number of data bits having a high state in the encoded set of data bits. For example, if the data page is encoded with a proportion of data bits with a high state equal to 50 percent, the number X is equal to the number of data bits in the set of data bits divided by 2. In the following example, the data page comprises 1000*1000 data bits and the set of data bits also comprises 1000*1000 data bits; the proportion of data bits with a high state in the encoded data page is equal to 50 percent. Hence the number X is 500000. If the number N of imaged data bits having a high state is larger than 500000, it means that some imaged data bits detected with a high state indeed correspond to data bits having a low state. As a consequence, the intensity of the radiation beam is lowered at step 304. This thus lowers the intensities of the imaged data bits. The set of imaged data bits is then detected at step 302, and the number of imaged data bits having a high state is counted at step 303. If this number N is still larger than 500000, the intensity of the radiation beam is again lowered at step 304. This is repeated until the number N is equal to 500000.

In the following example, the intensities of the imaged data bits is so low that no imaged data bit has a high state at step 303. For example, the largest intensity is 10, whereas the predetermined threshold is 50. This is possible if the diffraction efficiency of the data page is low, which may occur for example when the recording angle is large. In this case, the intensity of the radiation beam is increased at step 304. This increases the intensities of the imaged data bits. This is repeated until half of the intensities is superior to 50 and half is inferior to 50. As a consequence, the noise has no influence on the detection of the imaged data bits. For example, if the intensity of the noise is about 1, the influence of the noise on intensities having an average value of 50 is negligible.

Instead of the whole imaged data page, only a portion of the imaged data page may be detected at step 302. Actually, it may not be necessary to detect the whole imaged data page for modifying the intensity of the radiation beam. For example, if the data page has 1000*1000 data bits, it may be sufficient to detect only a portion of the data page having 100*100 data bits. Actually, the distribution of high and low states in this portion is usually statistically the same as the distribution in the whole data page.

Detection of only a portion of the imaged data page may also be advantageous if it is known that said portion has different properties than the rest of the data page. For example, if it is known that the intensities in a portion of the imaged data page are always larger than the intensities in the rest of the imaged data page, it may be advantageous to read out this portion with a radiation beam having a first intensity and the rest of the data page with a second radiation beam having a second, larger intensity.

The number X of data bits having a high state in the encoded set of data bits mainly depends on the holographic medium. Usually, the proportion of data bits having a high state is between 40 and 60 percent, and more usually it is substantially equal to 50 percent.

It should be noted that it may not be necessary to repeat steps 302, 303 and 304 for reaching the desired number of imaged data bits having a predetermined data state. Instead, a relation between the required intensity of the radiation beam and the number of imaged data bits having a predetermined data state may be stored in the holographic device. For example, the holographic device may comprise a look-up-table comprising the intensity of the radiation beam to be applied when a number N of data bits having a predetermined data state is measured with a certain intensity of the radiation beam.

It should also be noted that the method in accordance with the invention may be performed for one data page only, or for a few data pages only. For example, once the intensity of the radiation beam has been set for read-out of one data page, read-out of the next data page may not require modifying the intensity of the radiation beam, because the recording conditions of two consecutives data pages are similar. However, depending on the recording and read-out conditions, it can also be chosen to perform the method in accordance with the invention for each new data page that is read-out.

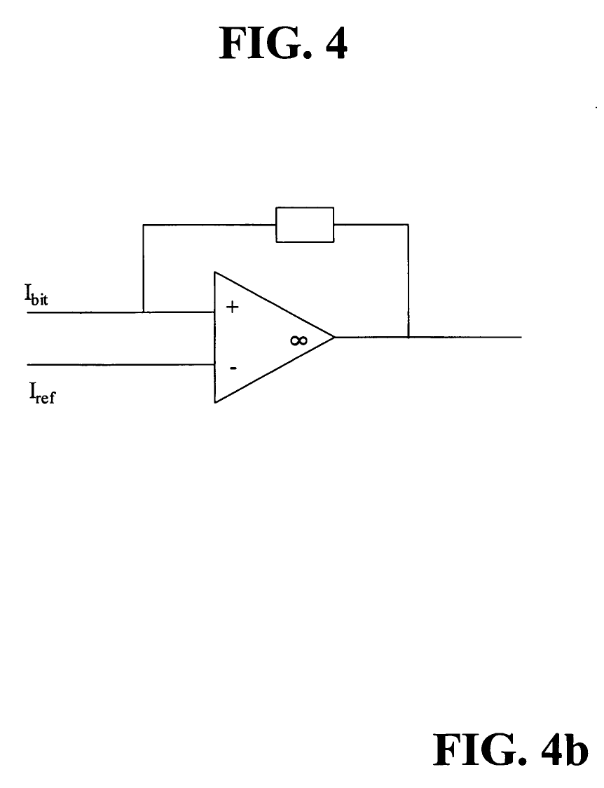

FIG. 4 illustrates a comparator that can be used for counting the number of imaged data bits having a predetermined data state. This comparator is a conventional comparator that compares the intensity I_{bit} of an imaged data bit with a reference intensity I_{ref}. The reference intensity I_{ref} corresponds to the predetermined threshold as described in FIGS. 2 and 3.

Hence, a relatively simple decision circuit is used in the counting means 204. This is particularly advantageous with respect to the prior art. In conventional holographic devices, and analogue to digital converter is used after each pixel of the detector. The output of the analogue to digital converter is then compared with a threshold in a detection circuit in order to decide if the imaged data bit has a high or a low state. A relatively large bit depth is required in the analogue to digital converter in order to get enough resolving resolution. For example, a bit depth of 8 to 12 bits may be required. Now, the detector has a limited output-signal bandwidth, and introducing an analogue to digital converter with a relatively large bit depth leads to a required bandwidth that is larger than the available bandwidth of the detector. This thus limits the total user bitrate of such a holographic device.

In the holographic device of the invention, a simple decision circuit can be used, because there is no need to measure the intensities of the imaged data bits accurately, as the method for reading out is based on a modification of the intensity of the radiation beam. As a consequence, use of the method in accordance with the invention increases the user bitrate.

It should be noted that a comparator as depicted in FIG. 4 may be used for a plurality of pixels of the detecting means. For example, the holographic device may comprise one comparator per row of pixels, or a unique comparator. In these cases, the intensities of the data bits are sent serially to the appropriate comparator.

The method for reading out a data page according to the invention can be implemented in an integrated circuit, which is intended to be integrated in an holographic device. A set of instructions that is loaded into a program memory causes the integrated circuit to carry out the method for reading out the data page. The set of instructions may be stored on a data carrier such as, for example, a disk. The set of instructions can be read from the data carrier so as to load it into the program memory of the integrated circuit, which will then fulfil its role.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical holographic device for reading out a data page recorded in a holographic medium (202), said data page comprising data bits, the device comprising means (200) for producing a radiation beam having an intensity, means (201) for directing said radiation beam towards said holographic medium so as to image said data page, means (203) for detecting a set of imaged data bits in said imaged data page, means (204) for counting, among said set of imaged data bits, the number of imaged data bits having a predetermined data state and means (205) for modifying said intensity as a function of said number.

2. An optical holographic device as claimed in claim 1, wherein the means for counting comprise at least one comparator for comparing the value of an imaged data bit with a predetermined threshold.

3. An optical holographic device as claimed in claim 1, wherein the means for modifying the intensity of the radiation beam are arranged for modifying the intensity of the radiation beam until said number represents between 40 percent and 60 percent of the number of imaged data bits of said set of imaged data bits.

4. An optical holographic device as claimed in claim 3, wherein the means for modifying the intensity of the radiation beam are arranged for modifying the intensity of the radiation beam until said number represents substantially 50 percent of the number of imaged data bits of said set of imaged data bits.

5. A method for reading out a data page recorded in a holographic medium, said data page comprising data bits, said method comprising a step (301) of forming an imaged data page from said data page on detecting means by means of a radiation beam having an intensity, a step (302) of detecting a set of imaged data bits in said imaged data page, a step (303) of counting, among said set of imaged data bits, the number of imaged data bits having a predetermined data state and a step (304) of modifying said intensity as a function of said number.

6. A method for reading out a data page as claimed in claim 5, wherein said counting step comprises a sub-step of comparing the value of an imaged data bit with a predetermined threshold.

7. A method for reading out a data page as claimed in claim 5, wherein said modifying step comprises modifying the intensity of the radiation beam until said number represents between 40 percent and 60 percent of the number of imaged data bits of said set of imaged data bits.

8. A method for reading out a data page as claimed in claim 7, wherein said modifying step comprises modifying the intensity of the radiation beam until said number represents substantially 50 percent of the number of imaged data bits of said set of imaged data bits.

9. A computer program comprising a set of instructions which, when loaded into a processor or a computer, causes the processor or the computer to carry out the method as claimed in claim 5.
